(19) United States
(12) Patent Application Publication
(10) Pub. No.: US 2022/0053332 A1
(43) Pub. Date: Feb. 17, 2022

(54) SECONDARY AUTHENTICATION FOR WWAN VPN

(71) Applicant: Apple Inc., Cupertino, CA (US)

(72) Inventors: Muthaiah VENKATACHALAM, Beaverton, OR (US); Abhijeet Ashok KOLEKAR, Hillsboro, OR (US); Sharada RAGHURAM, Buffalo Grove, IL (US); Roy UBRY, Beaverton, OR (US)

(21) Appl. No.: 17/299,128

(22) PCT Filed: Nov. 27, 2019
(86) PCT No.: PCT/US2019/063588

§ 371 Date: Jun. 2, 2021

Related U.S. Application Data
(60) Provisional application No. 62/779,350, filed on Dec. 13, 2018.

(51) Int. Cl. H04W 12/06; H04W 12/0471; H04L 29/06; H04W 12/03

(52) U.S. Cl. CPC H04W 12/068; H04W 12/0471; H04W 88/16; H04W 12/03; H04L 63/0272

(57) ABSTRACT

Systems and methods of providing secondary authentication credentials for an external network are described. The credentials are provided from the UE to the GGSN via the SGSN during establishment of a PDN connection for the UE in a NAS message. The SGSN receives an Activate PDP Context Request from the UE and sends to the GGSN a Create PDP Context Request. The Requests include a PCO IE with the credentials. The GGSN determines a RADIUS and/or DHCP server to be used for IP address allocation, a protocol to be used with the server, and security features to use to dialogue with the server. The GGSN obtains the IP address from the server and provides the IP address to the UE via the SGSN via Create PDP Context Response.

This application claims the benefit of priority to U.S. Provisional Patent Application Ser. No. 62/779,350, filed Dec. 13, 2018, which is incorporated herein by reference in its entirety.

### TECHNICAL FIELD

Embodiments pertain to radio access networks (RANs). Some embodiments relate to cellular networks, including Third Generation Partnership Project (3GPP) Long Term Evolution (LTE), 4^{th} generation (4G) and 5^{th} generation (5G) New Radio (NR) (or next generation (NG)) networks. Some embodiments relate to virtual private networks (VPNs).

### BACKGROUND

The use of various types of systems has increased due to both an increase in the types of devices user equipment (UEs) using network resources as well as the amount of data and bandwidth being used by various applications, such as video streaming, operating on these UEs. The variation in UEs and protocols used, as well as the environment in which UEs connect to access nodes has naturally led to a number of issues, one of which is security of data and devices. In an effort to reduce security issues, the use of VPNs has flourished. The VPN enables a UE to communicate data across unsecured public networks as if the UE was connected directly to the private network.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1 illustrates combined communication system in accordance with some embodiments.

FIG. 2 illustrates a block diagram of a communication device in accordance with some embodiments.

FIG. 3 illustrates connectivity in accordance with some embodiments.

FIGS. 4A and 4B illustrate UE authentication in accordance with some embodiments.

FIGS. 5A and 5B illustrate UE authentication in accordance with some embodiments.

FIG. 6 illustrates a flowchart of a method of performing secondary authentication by the UE in accordance with some embodiments.

FIG. 7 illustrates a flowchart of a method of performing secondary authentication by a packet gateway (P-GW) in accordance with some embodiments.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

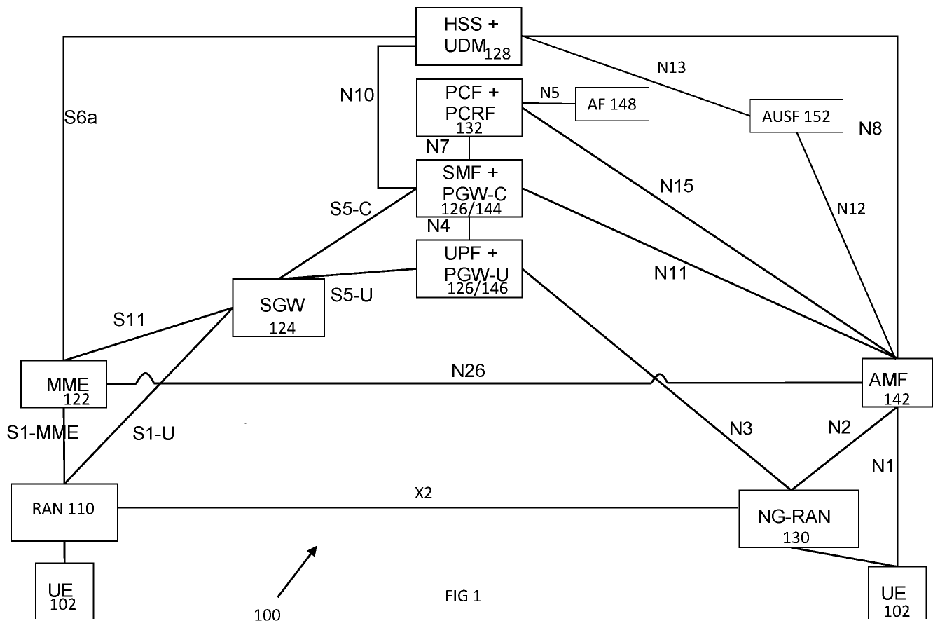

FIG. 1 illustrates a combined communication system in accordance with some embodiments. The system 100 includes 3GPP LTE/4G and NG network functions. A network function can be implemented as a discrete network element on a dedicated hardware, as a software instance running on dedicated hardware, or as a virtualized function instantiated on an appropriate platform, e.g., dedicated hardware or a cloud infrastructure.

The evolved packet core (EPC) of the LTE/4G network contains protocol and reference points defined for each entity. These core network (CN) entities may include a mobility management entity (MME) 122, serving gateway (S-GW) 124, and packet gateway (P-GW) 126.

In the NG network, the control plane and the user plane may be separated, which may permit independent scaling and distribution of the resources of each plane. The UE 102 may be connected to a radio access network (RAN) 110 and/or may be connected to the NG-RAN 130 (gNB) or an Access and Mobility Function (AMF) 142. The RAN 110 may be an eNB or a general non-3GPP access point, such as that for Wi-Fi. The NG core network may contain multiple network functions besides the AMF 112. The UE 102 may generate, encode and perhaps encrypt uplink transmissions to, and decode (and decrypt) downlink transmissions from, the RAN 110 and/or gNB 130 (with the reverse being true by the RAN 110/gNB 130).

The network functions may include a User Plane Function (UPF) 146, a Session Management Function (SMF) 144, a Policy Control Function (PCF) 132, an Application Function (AF) 148, an Authentication Server Function (AUSF) 152 and User Data Management (UDM) 128. The various elements are connected by the NG reference points shown in FIG. 1.

The AMF 142 may provide UE-based authentication, authorization, mobility management, etc. The AMF 142 may be independent of the access technologies. The SMF 144 may be responsible for session management and allocation of IP addresses to the UE 102. The SMF 144 may also select and control the UPF 146 for data transfer. The SMF 144 may be associated with a single session of the UE 102 or multiple sessions of the UE 102. This is to say that the UE 102 may have multiple 5G sessions. Different SMFs may be allocated to each session. The use of different SMFs may permit each session to be individually managed. As a consequence, the functionalities of each session may be independent of each other. The UPF 126 may be connected with a data network, with which the UE 102 may communicate, the UE 102 transmitting uplink data to or receiving downlink data from the data network.

The AF 148 may provide information on the packet flow to the PCF 132 responsible for policy control to support a desired QoS. The PCF 132 may set mobility and session management policies for the UE 102. To this end, the PCF 132 may use the packet flow information to determine the appropriate policies for proper operation of the AMF 142 and SMF 144. The AUSF 152 may store data for UE authentication. The UDM 128 may similarly store the UE subscription data.

The gNB 130 may be a standalone gNB or a non-standalone gNB, e.g., operating in Dual Connectivity (DC) mode as a booster controlled by the eNB 110 through an X2 or Xn interface. At least some of functionality of the EPC and the NG CN may be shared (alternatively, separate components may be used for each of the combined component shown). The eNB 110 may be connected with an MME 122 of the EPC through an S1 interface and with a SGW 124 of the EPC 120 through an S1-U interface. The MME 122 may be connected with an HSS 128 through an S6a interface while the UDM is connected to the AMF 142 through the N8 interface. The SGW 124 may connected with the PGW 126 through an S5 interface (control plane PGW-C through S5-C and user plane PGW-U through S5-U). The PGW 126 may serve as an IP anchor for data through the internet.

The NG CN, as above, may contain an AMF 142, SMF 144 and UPF 146, among others. The eNB 110 and gNB 130 may communicate data with the SGW 124 of the EPC 120 and the UPF 146 of the NG CN. The MME 122 and the AMF 142 may be connected via the N26 interface to provide control information there between, if the N26 interface is supported by the EPC 120. In some embodiments, when the gNB 130 is a standalone gNB, the 5G CN and the EPC 120 may be connected via the N26 interface.

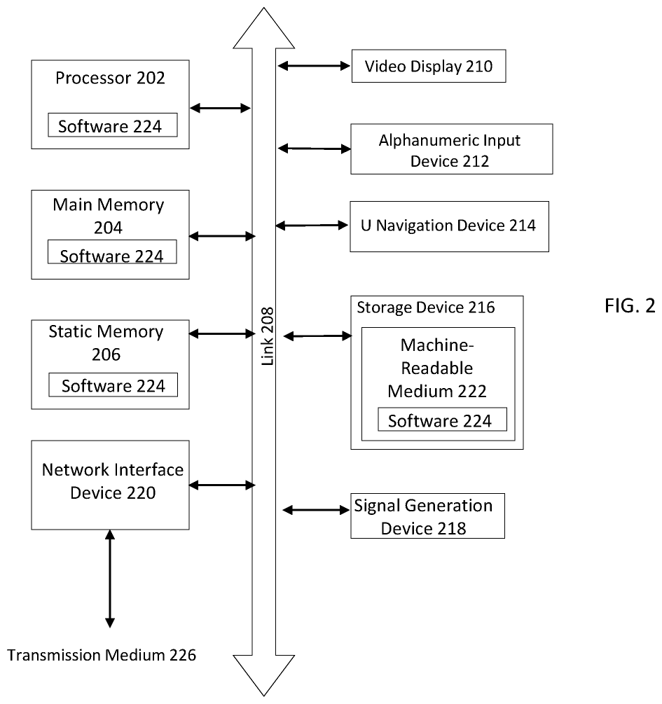

FIG. 2 illustrates a block diagram of a communication device in accordance with some embodiments. In some embodiments, the communication device may be a UE (including an IoT device and NB-IoT device), eNB, gNB or other equipment used in the network environment. For example, the communication device 200 may be a specialized computer, a personal or laptop computer (PC), a tablet PC, a mobile telephone, a smart phone, a network router, switch or bridge, or any machine capable of executing instructions (sequential or otherwise) that specify actions to be taken by that machine. In some embodiments, the communication device 200 may be embedded within other, non-communication-based devices such as vehicles and appliances.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, successfully or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a NG/NR standards among others. In an example, the network interface device 220 may include one or more physical jacks (e.g., Ethernet, coaxial, or phone jacks) or one or more antennas to connect to the transmission medium 226.

The communication device 200 may be an IoT device (also referred to as a “Machine-Type Communication device” or “MTC device”), a narrowband IoT (NB-IoT) device, or a non-IoT device (e.g., smart phone, vehicular UE), any which may communicate with the core network via the eNB or gNB shown in FIG. 1. The communication device 200 may be an autonomous or semiautonomous device that performs one or more functions, such as sensing or control, among others, in communication with other communication devices and a wider network, such as the Internet. If the communication device 200 is IoT device, in some embodiments, the communication device 200 may be limited in memory, size, or functionality, allowing larger numbers to be deployed for a similar cost to smaller numbers of larger devices. The communication device 200 may, in some embodiments, be a virtual device, such as an application on a smart phone or other computing device.

One consideration in the use of electronic devices, and in particular wireless communication devices, is battery life. One method by which power is conserved is called modern standby, which wakes the device when real time action is to be performed, such as operating system maintenance or based on user interaction that wakes the device. In modern standby, which replaces S3, the idle power of the electronic device is low enough to remain connected and maintain the content. In modern standby, the transition from the active to the low power state is a series of steps to lower power consumption, with components being powered down when not in use. VPN use is a barrier to enabling modern standby on a commercial client.

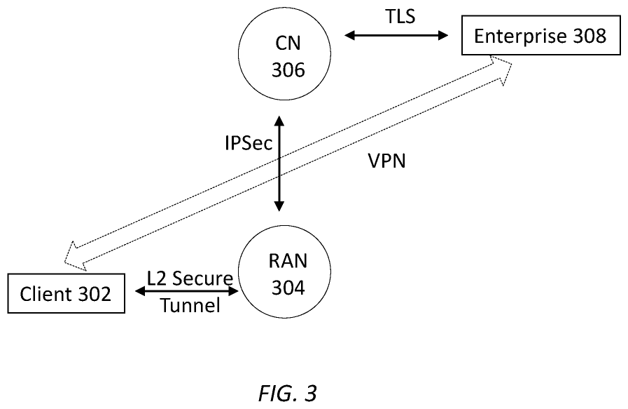

FIG. 3 illustrates connectivity in accordance with some embodiments. In an enterprise environment, VPNs are used for remote access to the enterprise network. However, the use of encrypted IP headers inside a VPN tunnel may cause a host to wake up for every packet. This may cause a barrier to 100% modern standby on a commercial client. In some embodiments, the use of VPN-less enterprise access may open up a new standby for the commercial client. The use of VPN-less enterprise access may also provide an enhanced user experience for the commercial client, as well as provide better access to the enterprise by headless devices, internet of things (IOT) gateways (GWs) and converged security management engines (CSMEs).

In particular, FIG. 3 illustrates a VPN that uses internet protocol (IP) security (IPSec) to provide data authentication, integrity, and confidentiality through the encryption and authentication of packets directly between a client (UE) 302 and an enterprise 308. FIG. 3 also illustrates an alternate path between the client 302 and the enterprise 308 in which the VPN is eliminated in a wireless wide area network (WWAN) when the user is on a trusted network as a connection of the client 302 to the external network (RAN 304) is already secured due to a 3GPP security architecture. As shown, such a secure connection between the client 302 and the RAN 304 may use a Layer 2 (L2) Secure Tunnel, IPSec protocols between the RAN 304 and the CN (or evolved packet core (EPC)) 306 and Transport Layer Security (TLS) between the CN 306 and the enterprise 308. Such an arrangement may enable the new standby on commercial PC platforms as well as an enhanced end user experience and reduced VPN deployment cost.

In the cellular modem of the client 302, primary authentication may be used to authenticate between the client 302 and CN 306. The master key generated during the primary authentication process may be used for generating keys that are used in encryption of the packets between the UE and the RAN. In this case, a secondary authentication procedure may be used for authentication with external data networks outside the mobile operator domain.

In LTE, secondary authentication may be performed through a Protocol Configuration Option (PCO) during PDN connection establishment. The PCO is part of a non-access stratum (NAS) message carried by a PDN Connectivity Request (in which the UE requests desired information), ActivateDefaultEPSBearerContextRequest, or ActivateDefaultEPSBearerContextAccept. The PCO may be a 2-part procedure and only support Password Authentication Protocol (PAP)/Challenge Handshake Authentication Protocol (CHAP) based authentication.

In 5G, secondary authentication may be a multi-part procedure that allows other authentication procedures such as Extensible Authentication Protocol (EAP) and Key Agreement (EAP-AKA), Tunneled Transport Layer Security (TTLS) or any other 3rd party authentication mechanism used for the external data network. The 3GPP network may apply the EAP framework for authentication and key agreement for non-3GPP access to the EPC for the same reasons the EAP framework is used for 3G-WLAN inter-working. These reasons include that the EAP framework enables use of the same authentication and key agreement procedure across different types of access networks, as well as uniform generation and distribution of keys. In addition, possibly established credential infrastructures can be re-used. One aspect that is specific to the type of access network is the way in which the transport of EAP messages is supported. The peer resides on the UE, and the EAP server resides on the 3GPP Authentication, Authorization, and Accounting (AAA) server.

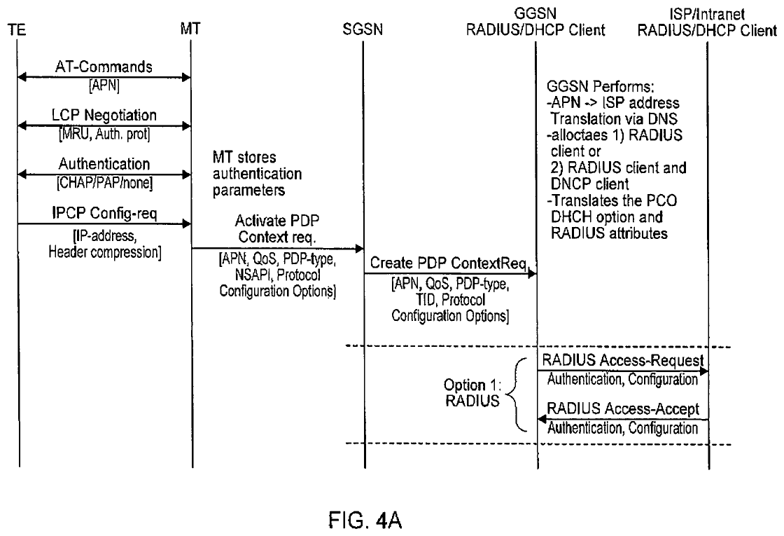

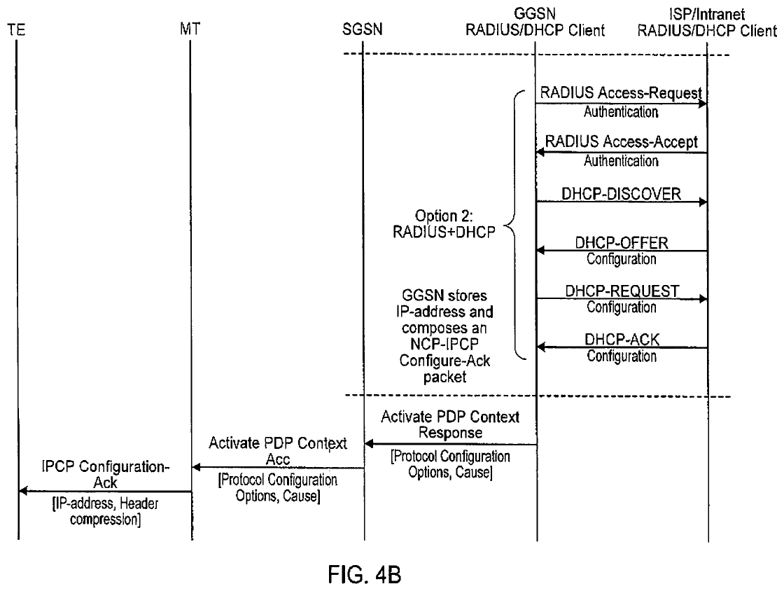

FIGS. 4A and 4B illustrate UE authentication in accordance with some embodiments. In particular, LTE authentication is shown in FIGS. 4A and 4B. As illustrated, the UE contains the Terminal Equipment (TE) and Mobile Termination (MT). The TE may send attention (AT) commands to the TA, which are then parsed as MT control commands. The AT commands can include, for example, general commands, call control commands, network service related commands, MT control and status commands, MT errors result codes, commands for packet domain, commands for voice group call service (VGCS) and voice broadcast service (VBS), and commands for the Universal Subscriber Identity Module (USIM) Application Toolkit.

The MT and TE may also engage in a Link Control Protocol (LCP) negotiation. This may include the Maximum Receive Unit (MRU) size that is always accepted, and the authentication protocol used during the authentication phase of the connection. After the LCP negotiation, the TE may provide PAP/CHAP authentication credentials to the MT, where the credentials may be stored. The TE may then send an Internet Protocol Control Protocol (IPCP) Config-req that contains the IP address (either a static IP address or a dynamically allocated IP address) and header compression to the MT. The MT of the UE, in response, may send an activate Packet Data Protocol (PDP) context request to the Serving General Packet Radio Service (GPRS) Support Node (SGSN). The SGSN forms a gateway to services within the network, providing services including packet routing and transfer, mobility management, logical link management, authentication and charging. The activate PDP context request may include the Access Point Name (APN), Quality of Service (QoS), PDP-type, Network (Layer) Service Access Point Identifier (NSAPL) and PCO.

The UE may thus provide the PAP/CHAP user credentials in the PCO information element (IE) when accessing the evolved packet system (EPS) on 3GPP and non-3GPP IP accesses. The PAP/CHAP user credentials may be used to match VPN enterprise credentials. The PCO IE may thus be used to provide the authentication credentials for secondary authentication without a separate later request, e.g., by an application on the UE.

The SGSN may in response send a create PDP context request to a Gateway GPRS Support Node (GGSN), which is also the P-GW in 4G, including the unmodified PCO. The GGSN may allocate a RADIUS/DHCP client. The GGSN, which may be a wireless router, connects GSM-based 3G networks to the Internet, using the SGSN to keep mobile users connected to the Internet and IP-based applications. The GGSN converts incoming traffic from mobile UEs (via the SGSN) and forwards the data to external networks, and provides outgoing traffic to the UE in the same manner.

The PDP context request may include the APN, QoS, PDP-type, tunnel identifier (TID) and PCO. If the PCO is provided to the GGSN, the P-GW may perform secondary authentication (user authentication) based on these credentials. For an S2c interface (trusted non-3GPP IP access) between the UE and the P-GW, the P-GW may receive the credentials from the UE based on Internet Engineering Task Force (IETF) Request for Comments (RFC) 4739 during the establishment of security association signaling via Internet Key Exchange Version 2 (IKEv2), though embodiments herein are not necessarily limited to IETF RFC 4739. The S2c interface may be used when UE attaches via trusted non-3GPP access and DSMIPv6 is used. For an S2b interface between the evolved packet data gateway (ePDG) and the P-GW, the UEs may provide the credentials in the IKEv2 protocol as specified in IETF RFC 4739, though embodiments herein are not necessarily limited to IETF RFC 4739, and if the ePDG supports multiple authentications, the credentials may be included in the Additional Protocol Configuration Options (APCO) IE (per 3GPP TS 29.275, subclause 12.1.1.19) on the S2b interface. The APCO IE may include the VPN context. The VPN context may include one or more of the following parameters: VPN server/gateway Endpoint Address, VPN tunneling type, or VPN security credential/certificate. The S2b interface may be used when the UE attaches via untrusted access and PMIPv6 is used; the UE receives the IP address from the PDN during the IKEv2-based authentication with the ePDG.

The GGSN translates the APN to an internet service provider (ISP) address using the domain name server (DNS). The GGSN/P-GW also allocates a Remote Authentication Dial In User Service (RADIUS) client or a RADIUS client and Dynamic Host Configuration Protocol (DHCP) client. The GGSN also translates the PCO DHCP option and RADIUS attributes. The GGSN thus determines the server(s) to be used for address allocation, authentication and protocol configuration options retrieval, the protocol (RADIUS, DHCP) to be used with the server(s), and the communication and security feature to dialogue with the server(s) (tunnel, IPSec security association, dial-up connection).

If the GGSN allocates a RADIUS client alone, the GGSN may send a RADIUS Access-Request to the ISP (which is also a RADIUS server and DHCP server). The information in each RADIUS message (e.g., Access-Request, Access-Accept, Access-Reject) may be encapsulated in a User Datagram Protocol (UDP) data packet. The RADIUS packet fields include the code, the identifier, the length, the authentication information, and the attribute(s). The code indicates the type of RADIUS message: Access-Request, Access-Accept, Access-Reject, Access-Challenge, Accounting-Request, or Accounting-Response. The identifier contains a value copied into the server's response so the client can correctly associate its requests and the server's responses when multiple users are being authenticated simultaneously. The length provides a mechanism for error-checking; the server drops a packet if it is shorter than the value specified in the length field and ignores the octets beyond the value of the length field. The authentication information contains a value for a Request Authenticator or a Response Authenticator. The Request Authenticator is included in a client's Access-Request. The value may be unique, and added to the client/server shared secret so the combination can be run through a one-way algorithm. The NAS then uses the result in conjunction with the shared secret to encrypt a password, for example. The attributes depend on the type of message being sent.

The RADIUS Access-Request may contain information that allows the RADIUS server to determine whether to allow access to a specific network access server, which will allow access to the user. The RADIUS Access-Request may contain the authentication information of the UE as well as the configuration (IP address allocation).

The ISP server may respond with a RADIUS Access-Accept. After the RADIUS server receives an Access-Request packet, the RADIUS server may send a RADIUS Access-Accept packet if all attribute values in the RADIUS Access-Request packet are acceptable. The RADIUS Access-Accept may contain the authentication information of the UE as well as the configuration for the client to provide service to the user.

If the GGSN allocates a RADIUS client and DHCP client, as described above, the GGSN may send a RADIUS Access-Request to the ISP, which responds with a RADIUS Access-Accept. The RADIUS Access-Request may provide the authentication information to the ISP without providing the configuration. Instead, after the ISP provides the RADIUS Access-Accept to the GGSN, the GGSN may transmit a separate DHCP-DISCOVER message to the ISP to find the DHCP server. The ISP may respond with a DHCP-OFFER message that offers the GGSN configuration (e.g., an IPv4 address). The GGSN may store the IP address and compose an NCP-IPCP Configure-ACK packet. The GGSN may transmit to the ISP, in response to the DHCP-OFFER message, a DHCP-REQUEST message that indicates the GGSN has accepted the offer. The ISP may respond to the DHCP-REQUEST message with a DHCP-ACK message that the ISP has accepted the request. Thus, after a successful authentication, the DHCP client discovers the DHCP server(s) in the ISP/Intranet and receives host configuration data.

Whether the GGSN allocates the RADIUS client alone or the RADIUS client and DHCP client, the GGSN may compose an NCP-IPCP Configure-ACK packet. The GGSN transmits a PDP Context Response message to the SGSN. The PDP Context Response message may contain the PCO containing the configuration and cause indicating the message type. The cause value may set according to the outcome of the host—authentication and—configuration. The PCO and cause may be forwarded by the SGSN to the MT in an Activate PDP Context Ack message. The MT, in turn, may provide an IPCP Configuration-Ack message to the TE. The IPCP Configuration-Ack message contains the IP address and header compression. If PCO are received from the GGSN, the SGSN may relay the PCO to the UE.

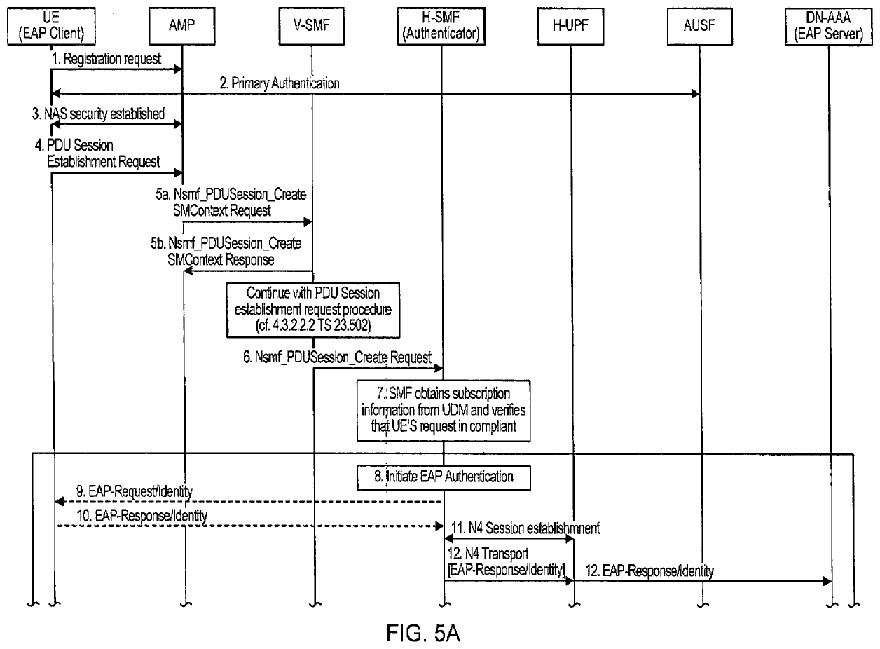

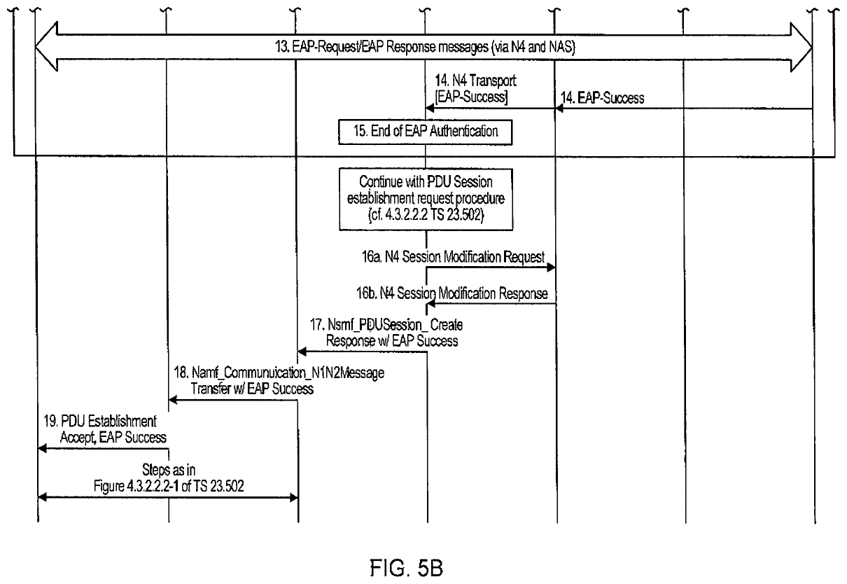

FIGS. 5A and 5B illustrate UE authentication in accordance with some embodiments. As shown, the UE may initially send a registration request to the AMF. The UE may exchange primary authentication information with the AUSF. After primary authentication is established, the UE may communicate with the AMF indicating that NAS security has been established and then send a PDU session establishment request to the AMF.

The AMF may transmit a Nsmf PDU Session Create SMContext Request to the SMF (which may be for a visiting SMF (V-SMF) as shown). The SMF may respond to the AMF with a Nsmf PDU Session Create SMContext Response accepting the request. The SMF may continue with the PDU session establishment request procedure and send a Nsmf PDU Session Create Request to the Home-SMF (H-SMF). The H-SMF may obtain subscription information from the UDM and verify that the request from the UE is compliant with the policy stored in the PCF.

The H-AMF may then initiate EAP authentication, sending an EAP Request/Identity request to the UE, which may respond with an EAP Response/Identity. After receiving the EAP Response/Identity from the UE, the H-SMF may negotiate N4 Session establishment with the H-UPF. The H-SMF may, after the N4 Session is established, transmit an N4 Transport message containing the EAP Response/Identity to the H-UPF. The H-UPF may then transmit the EAP Response/Identity to the DN-AAA (which is the EAP server). The DN-AAA may exchange EAP Request and EAP Response messages with the UE via the N4 and NAS connections that have been established. The DN-AAA, once the EAP Request and EAP Response messages have been sent, indicate success to the H-UPF using an EAP Success message. The H-UPF may in response send an N4 transport message containing the EAP Success message, after which case the EAP authentication is completed.

The H-SMF may continue with the PDU session establishment request procedure, sending an N4 Session modification request message to the H-UPF, and receiving in response an N4 Session modification response indicating success. The H-SMF may then transmit to the V-SMF a Nsmf PDU Session Create Response message with the EAP success information. The V-SMF may then send to the AMF a Namf communication N1N2 message transfer message that contains the EAP success information. The AMF may in response transmit to the UE a Nsmf PDU Establishment accept message that contains the EAP success information.

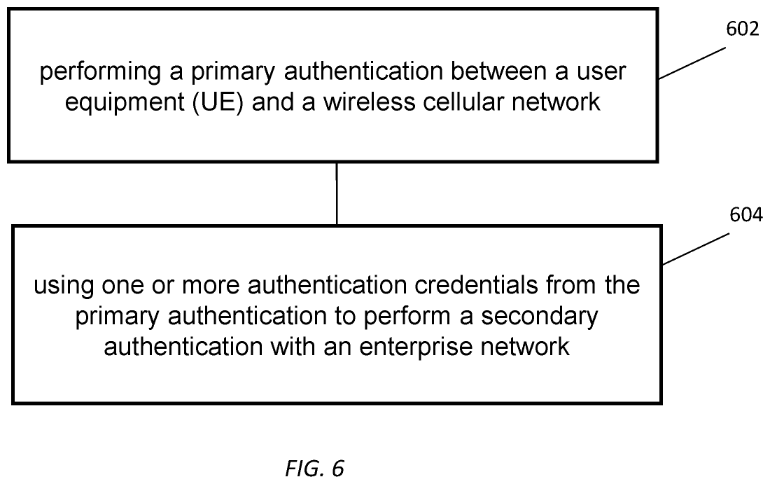

FIG. 6 illustrates a flowchart of a method of performing secondary authentication by the UE in accordance with some embodiments. The method may include performing a primary authentication between a UE and a wireless cellular network at operation 602. The UE may then use one or more authentication credentials from the primary authentication to perform a secondary authentication with an enterprise network at operation 604.

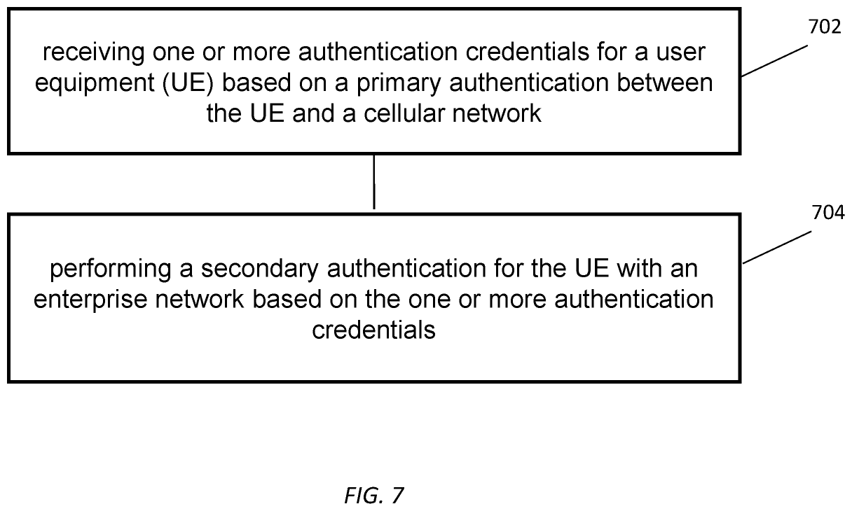

FIG. 7 illustrates a flowchart of a method of performing secondary authentication by a packet gateway (P-GW) in accordance with some embodiments. The method may include receiving one or more authentication credentials for a UE based on a primary authentication between the UE and a cellular network at operation 702. The method may continue by the P-GW performing a secondary authentication for the UE with an enterprise network based on the one or more authentication credentials at operation 704.

Although an aspect has been described with reference to specific example aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single aspect for the purpose of streamlining the disclosure. This method of disclosure is not to be interpreted as reflecting an intention that the claimed aspects require more features than are expressly recited in each claim. Rather, as the following claims reflect, inventive subject matter lies in less than all features of a single disclosed aspect. Thus, the following claims are hereby incorporated into the Detailed Description, with each claim standing on its own as a separate aspect.

What is claimed is:

1. An apparatus of a packet gateway (P-GW), the apparatus comprising:
processing circuitry configured to:
decode, from a Serving General Packet Radio Service (GPRS) Support Node (SGSN), secondary authentication credentials of a user equipment (UE) for trusted access during establishment of a packet data network (PDN) connection for the UE; and
authenticate the UE with at least one external server using the secondary authentication credentials; and
a memory configured to store the secondary authentication credentials.

2. The apparatus of claim 1, wherein the PCO IE is contained in a non-access stratum (NAS) message carried by a packet data network (PDN) Connectivity Request.

3. The apparatus of claim 2, wherein the processing circuitry is further configured to decode, from the SGSN, a Create PDP Context Request that comprises the secondary authentication credentials.

4. The apparatus of claim 1, wherein the secondary authentication credentials are provided in a Protocol Configuration Option (PCO) information element (IE).

5. The apparatus of claim 4, wherein the PCO IE comprises at least one of a Password Authentication Protocol (PAP) or Challenge Handshake Authentication Protocol (CHAP) user credentials.

6. The apparatus of claim 1, wherein the processing circuitry is further configured to decode, from the UE via an S2c interface, the secondary authentication credentials based on Internet Engineering Task Force (IETF) Request for Comments (RFC) 4739 during establishment of security association signaling via Internet Key Exchange Version 2 (IKEv2).

7. The apparatus of claim 1, wherein the processing circuitry is further configured to decode, from the UE via an S2b interface, the secondary authentication credentials based on Internet Engineering Task Force (IETF) Request for Comments (RFC) 4739 during establishment of security association signaling via Internet Key Exchange Version 2 (IKEv2), and the secondary authentication credentials are provided in an Additional Protocol Configuration Options (APCO) information element (IE) if multiple authentications are supported.

8. The apparatus of claim 7, wherein:
the APCO IE includes a virtual private network (VPN) context that comprises at least one of: VPN server/gateway Endpoint Address, VPN tunneling type, or VPN security credential/certificate.

9. The apparatus of claim 1, wherein the processing circuitry is further configured to:
encode, for transmission to a Remote Authentication Dial In User Service (RADIUS) server, a RADIUS Access-Request message comprising the secondary authentication credentials; and
decode, from the RADIUS server in response to transmission of the RADIUS Access-Request message, a RADIUS Access-Accept message comprising the secondary authentication credentials.

10. The apparatus of claim 9, wherein:
the processing circuitry is further configured to allocate a RADIUS client without allocation of a DHCP client,
the RADIUS Access-Request further includes a configuration that comprises the RADIUS client, and
the RADIUS Access-Request further includes another configuration that comprises the RADIUS client and the RADIUS server.

11. The apparatus of claim 9, wherein the processing circuitry is further configured to:
allocate a RADIUS client and a DHCP client,
encode a DHCP Discover message, the DHCP Discover message comprising a configuration that includes the DCHP client, and
decode the DHCP Offer message from the DHCP server, the DHCP Offer method comprising another configuration that comprises the DCHP client.

12. An apparatus of a Serving General Packet Radio Service (GPRS) Support Node (SGSN), the apparatus comprising:
processing circuitry configured to:
decode, from a user equipment (UE), secondary authentication credentials for trusted access during establishment of a packet data network (PDN) connection; and
encode, for transmission to a PDN gateway (P-GW), the secondary authentication credentials for authentication of the UE with at least one external server using the secondary authentication credentials,
wherein the secondary authentication credentials are provided in a Protocol Configuration Option (PCO) information element (IE);
a memory configured to store the secondary authentication credentials.

13. The apparatus of claim 12, wherein the PCO IE is contained in a non-access stratum (NAS) message carried by a packet data network (PDN) Connectivity Request.

14. The apparatus of claim 13, wherein the processing circuitry is further configured to decode, from the UE, an Activate PDP Context Request that comprises the secondary authentication credentials and encode, for transmission to the P-GW, a Create PDP Context Request that comprises the secondary authentication credentials.

15. The apparatus of claim 12, wherein the PCO IE comprises at least one of a Password Authentication Protocol (PAP) or Challenge Handshake Authentication Protocol (CHAP) user credentials.

16. A non-transitory computer-readable storage medium that stores instructions for execution by one or more processors of a Gateway GPRS Support Node (GGSN), the one or more processors to configure the GGSN to, when the instructions are executed:
receive, from a Serving General Packet Radio Service (GPRS) Support Node (SGSN), a Create PDP Context Request comprising a Protocol Configuration Option (PCO) information element (IE);
determine, from the PCO IE, secondary authentication credentials of a user equipment (UE) for external authentication of the UE, a server to be used for internet protocol (IP) address allocation, and a protocol to be used with the server;
communicate with the server to obtain an IP address; and
send to the UE via the SGSN, the IP address.

17. The medium of claim 16, wherein the PCO IE comprises at least one of a Password Authentication Protocol (PAP) or Challenge Handshake Authentication Protocol (CHAP) user credentials.

18. The medium of claim 16, wherein the one or more processors further configure the GGSN to, when the instructions are executed:
receive, from the UE via an S2c interface, the secondary authentication credentials based on Internet Engineering Task Force (IETF) Request for Comments (RFC) 4739 during establishment of security association signaling via Internet Key Exchange Version 2 (IKEv2).

19. The medium of claim 16, wherein the one or more processors further configure the GGSN to, when the instructions are executed:
receive, from the UE via an S2b interface, the secondary authentication credentials based on Internet Engineering Task Force (IETF) Request for Comments (RFC) 4739 during establishment of security association signaling via Internet Key Exchange Version 2 (IKEv2), and the secondary authentication credentials are provided in an Additional Protocol Configuration Options (APCO) information element (IE) if multiple authentications are supported.

20. The medium of claim 19, wherein:
the APCO IE includes a virtual private network (VPN) context that comprises at least one of: VPN server/gateway Endpoint Address, VPN tunneling type, or VPN security credential/certificate.

21. The medium of claim 16, wherein the one or more processors further configure the GGSN to, when the instructions are executed:
send to a Remote Authentication Dial In User Service (RADIUS) server, a RADIUS Access-Request message comprising the secondary authentication credentials; and
receive, from the RADIUS server in response to transmission of the RADIUS Access-Request message, a RADIUS Access-Accept message comprising the secondary authentication credentials.
